(19) United States
(12) Patent Application Publication
(10) Pub. No.: US 2007/0138126 A1
(43) Pub. Date: Jun. 21, 2007

(54) Methods of forming a conductive structure

(75) Inventors: Keum-Joo Lee, Hwaseong-si (KR); In-Seak Hwang, Suwon-si (KR); Jong-Won Kim, Hwaseong-si (KR)

Correspondence Address: HARNESS, DICKEY & PIERCE, P.L.C., P.O. BOX 8910, RESTON, VA, 20195, US

(73) Assignee: Samsung Electronics Co. Ltd.

(21) Appl. No.: 11/604,825

(22) Filed: Nov. 28, 2006

(30) Foreign Application Priority Data
Dec. 15, 2005 (KR) 10-2005-0123896

(51) Int. Cl. H01B 13/00; B44C 1/22; C03C 25/68; C03C 15/00

(52) U.S. Cl. 216/13; 216/83; 216/99

(57) ABSTRACT

Example embodiments relate to a method of forming a conductive structure. Other example embodiments relate to a method of forming a conductive structure capable of storing or transmitting electric charges. In example embodiments, when a conductive structure including first and second conductive patterns extending in a first horizontal direction is formed, at least one of the first and second conductive patterns may decreases in size. When the conductive structure is vertically bisected in a second horizontal direction perpendicular to the first horizontal direction to form conductive members, a coupling effect generated between the conductive members adjacent to each other may be reduced.

### PRIORITY STATEMENT

This application claims benefit of priority under 35 U.S.C. §119 from Korean Patent Application No. 10-2005-0123896, filed on Dec. 15, 2005 in the Korean Intellectual Property Office, the disclosure of which is incorporated herein by reference in its entirety.

### BACKGROUND

1. Field

Example embodiments relate to methods of forming a conductive structure. Other example embodiments relate to methods of forming a conductive structure capable of storing or transmitting electric charges.

2. Description of the Related Art

Generally, a non-volatile memory device may include a floating gate, a dielectric layer and/or a control gate. The floating gate may store electric charges. The dielectric layer may be positioned between the floating gate and the control gate. A surface area of the dielectric layer may be proportional to a coupling ratio of the floating gate and the control gate. If the coupling ratio of the floating gate and the control gate increases, then reliability of the non-volatile memory device may increase.

The conventional art acknowledges a method of manufacturing a non-volatile memory device capable of increasing the coupling ratio. According to the conventional methods of manufacturing the non-volatile memory device, conductive structures extending in a first horizontal direction may be bisected in a second horizontal direction substantially perpendicular to the first horizontal direction to form a plurality of floating gates (wherein bisecting means to divide into at least two). The floating gates may be spaced apart from one another in the first and second horizontal directions. Each floating gate may have at least one first side that faces a first side of second floating gate in the first horizontal direction and/or a second side that faces a second side of a third floating gate in the second horizontal direction. The first side may have a substantially “U” shape.

If an area of a first side increases, then a coupling ratio between adjacent first sides may increase. For example, in the scenario described above, the coupling ratio between adjacent first sides of the first and second floating gates, or the first and third floating gates, may increase. If the coupling ratio between adjacent first sides increases, then reliability of the non-volatile memory device may decrease.

### SUMMARY

Example embodiments relate to a method of forming a conductive structure. Other example embodiments relate to a method of forming a conductive structure capable of storing or transmitting electric charges.

Example embodiments provide a method of forming a conductive structure capable of decreasing a coupling effect between conductive members formed by reducing the conductive structures.

According to example embodiments, a method is provided including forming insulating layer patterns; and forming conductive layer patterns by removing at least a portion of an upper surface of at least one preliminary conductive structure, wherein the upper surface of the preliminary conductive structures is positioned higher than an upper surface of a section of the insulating layer pattern. The insulating layer patterns may include a lower section having first width, w₁, and an upper section having second width, w₂, wherein the expression w₂<w₁ is satisfied. The preliminary conductive structures may include a preliminary first conductive layer pattern or a second conductive layer.

In accordance with example embodiments, there is provided another method of forming a conductive structure. In the method provided an insulating layer pattern may be formed. The insulating layer pattern may include a lower portion having a first width and an upper portion having a second width substantially smaller than the first width. A preliminary first conductive layer pattern may be formed between the insulating layer patterns. The preliminary first conductive layer pattern may have an upper surface substantially higher than an upper surface of the lower portion. First conductive layer pattern may be formed by removing surface (or portion) of the preliminary first conductive layer pattern. A second conductive layer pattern may be formed on the first conductive layer pattern.

In accordance with example embodiments, there is provided another method of forming a conductive structure. In the method provided, an insulating layer pattern may be formed. The insulating layer pattern may include a lower portion having a first width and an upper portion having a second width substantially smaller than the first width. A first conductive layer pattern may be formed between the insulating layer patterns. A preliminary second conductive layer pattern may be formed on the insulating layer pattern and the first conductive layer pattern. A surface (or portion) of the preliminary second conductive layer pattern may be removed to form a second conductive layer. A portion of the second conductive layer, which has a higher height than (or are above) an upper surface of the insulating layer pattern, may be removed to form second conductive layer pattern.

According to example embodiments, a sectional area, which is formed as a result of vertically bisecting a conductive structure extending in a first horizontal direction in a second direction substantially perpendicular to the first horizontal direction, may be reduced.

If the conductive structures are vertically bisected in the second horizontal direction to form conductive members each having at least one first sidewall facing a first sidewall of another conductive member in the first horizontal direction and possibly at least one second sidewall facing a second sidewall of another conductive member in the second horizontal direction, then a coupling effect generated between first sidewalls that are adjacent to each other may be reduced.

### BRIEF DESCRIPTION OF THE DRAWINGS

Example embodiments will be more clearly understood from the following detailed description taken in conjunction with the accompanying drawings. FIGS. 1-22 represent non-limiting, example embodiments as described herein.

FIGS. 1 to 11 are diagrams illustrating cross-sectional views of a method of forming a conductive structure according to example embodiments;

FIGS. 12 to 17 are diagrams illustrating cross-sectional views of a method of forming a conductive structure according to example embodiments; and

FIGS. 18 to 22 are diagrams illustrating cross-sectional views of a method of forming a conductive structure according to example embodiments.

### DESCRIPTION OF EXAMPLE EMBODIMENTS

Example embodiments will be described with reference to the accompanying drawings. Example embodiments may, however, be embodied in many different forms and should not be construed as limited to the embodiments set forth herein. Rather, the embodiments are provided so that disclosure will be thorough and complete, and will fully convey the scope of example embodiments to those skilled in the art. The principles and features of example embodiments may be employed in varied and numerous embodiments. In the drawings, the size and relative sizes of layers and regions may be exaggerated for clarity. The drawings are not to scale. Like reference numerals designate like elements throughout the drawings.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives. Like numbers refer to like elements throughout the description of the figures.

It will also be understood that when an element or layer is referred to as being “on,” “connected to” and/or “coupled to” another element or layer, the element or layer may be directly on, connected and/or coupled to the other element or layer or intervening elements or layers may be present. In contrast, when an element is referred to as being “directly on,” “directly connected to” and/or “directly coupled to” another element or layer, no intervening elements or layers are present. As used herein, the term “and/or” may include any and all combinations of one or more of the associated listed items.

It will also be understood that, although the terms first, second, etc. may be used herein to describe various elements, components, regions, layers and/or sections. These elements, components, regions, layers and/or sections should not be limited by these terms. These terms may be used to distinguish one element, component, region, layer and/or section from another element, component, region, layer and/or section. For example, a first element, component, region, layer and/or section discussed below could be termed a second element, component, region, layer and/or section without departing from the teachings of example embodiments.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (rotated 90 degrees or at other orientations) and the spatially relative descriptors used herein interpreted accordingly.

The terminology used herein is for the purpose of describing particular embodiments only and is not intended to limit example embodiments. As used herein, the singular terms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of this specification and the relevant art and will not be interpreted in an idealized and/or overly formal sense unless expressly so defined herein.

Embodiments are described with reference to cross-sectional illustrations that are schematic illustrations of idealized embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated as a rectangle will, typically, have rounded or curved features. Thus, the regions illustrated in the figures are schematic in nature of a device and are not intended to limit the scope of example embodiments.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or” includes any and all combinations of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which the example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the claims are not limited to cover only example embodiments described.

Example embodiments relate to methods of forming a conductive structure. Other example embodiments relate to methods of forming a conductive structure capable of storing or transmitting electric charges.

FIGS. 1 to 11 are diagrams illustrating cross-sectional views of a method of forming a conductive structure according to example embodiments. FIGS. 1 to 11 are cross-sectional views taken along a first horizontal direction.

Referring to FIG. 1, a first insulating layer 110, a first conductive layer 120 and a mask layer pattern 130 may be successively formed on a preliminary substrate 100. The first insulating layer 110 may be formed of an insulating material (e.g., silicon oxide). The first conductive layer 120 may be formed of a conductive material (e.g., metal or polysilicon doped with impurities). The mask layer pattern 130 may extend in a second horizontal direction substantially perpendicular to a first horizontal direction. The mask layer pattern 130 may have an etching selectivity with respect to the first conductive layer 120, the first insulating layer 110 and/or the preliminary substrate 100. If the first conductive layer 120, the first insulating layer 110 and the preliminary substrate 100 are formed of polysilicon doped with impurities, silicon oxide and silicon, respectively, then the mask layer pattern 130 may be formed of silicon nitride.

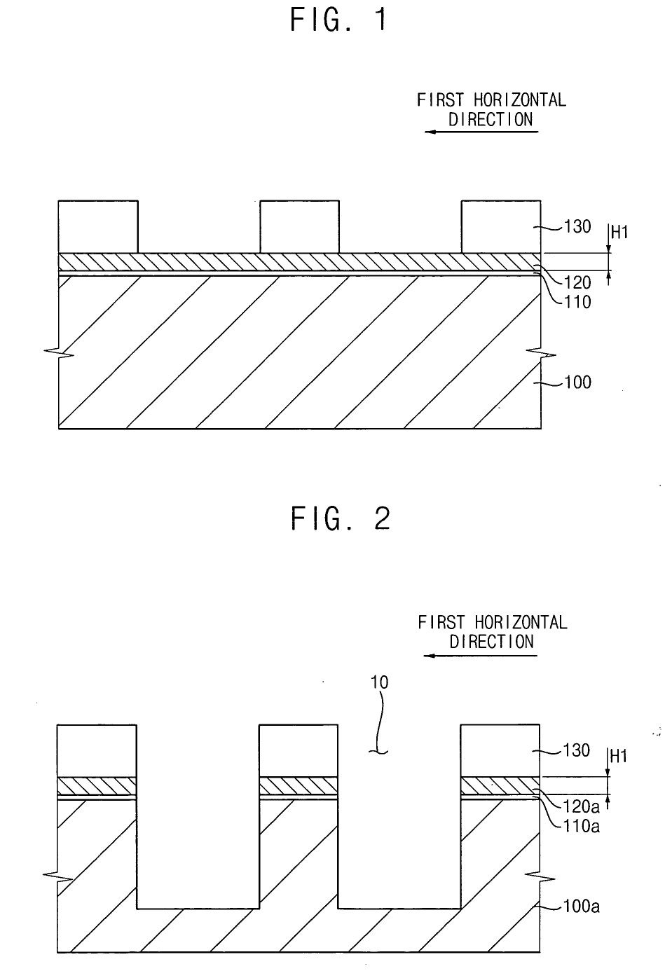

Referring to FIG. 2, the first conductive layer 120, the first insulating layer 110 and the preliminary substrate 100 may be successively etched using the mask layer pattern 130 as an etch mask. A preliminary first conductive layer pattern 120a, first insulating layer pattern 110a and a substrate 100a may be formed. The preliminary first conductive layer pattern 120a may have a first height H₁.

The mask layer pattern 130, preliminary first conductive layer pattern 120a, first insulating layer pattern 110a and substrate 100a may collectively form a plurality of grooves 10 extending in the second horizontal direction.

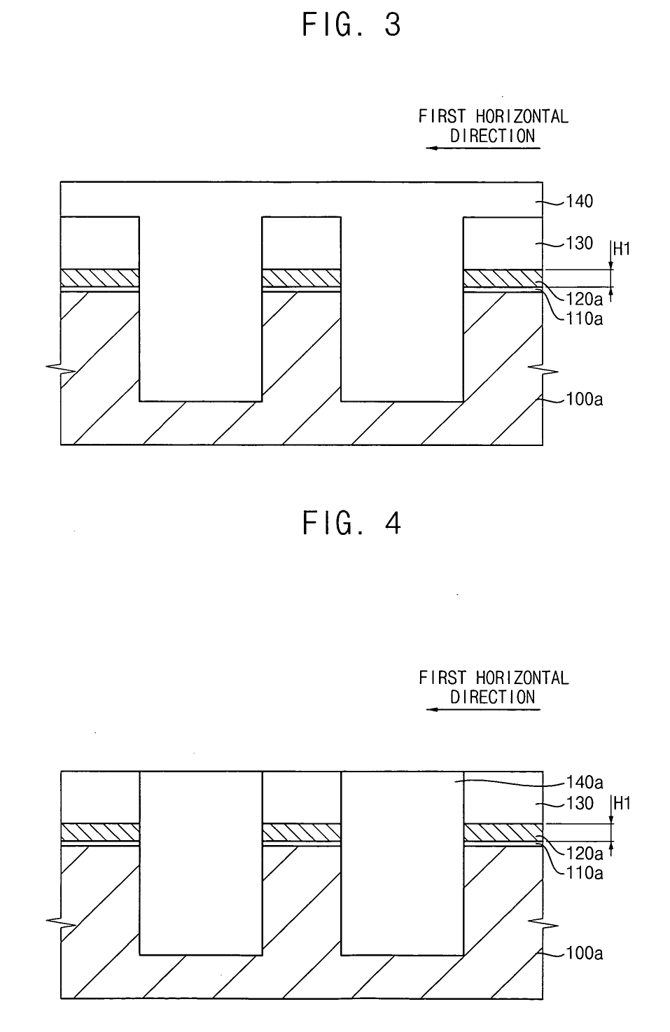

Referring to FIG. 3, a second insulating layer 140 may be formed on the mask layer pattern 130, preliminary first conductive layer pattern 120a, first insulating layer pattern 110a and substrate 100a in order to fill the grooves 10. The second insulating layer 140 may be formed of an insulating material (e.g., silicon oxide).

Referring to FIG. 4, a planarizing process may be performed on the second insulating layer 140 until the mask layer pattern 130 is exposed. A preliminary second insulating layer pattern 140a may be formed in the grooves 10. The planarizing process may be a chemical mechanical polishing (CMP) process or an etch-back process, used alone or in combination.

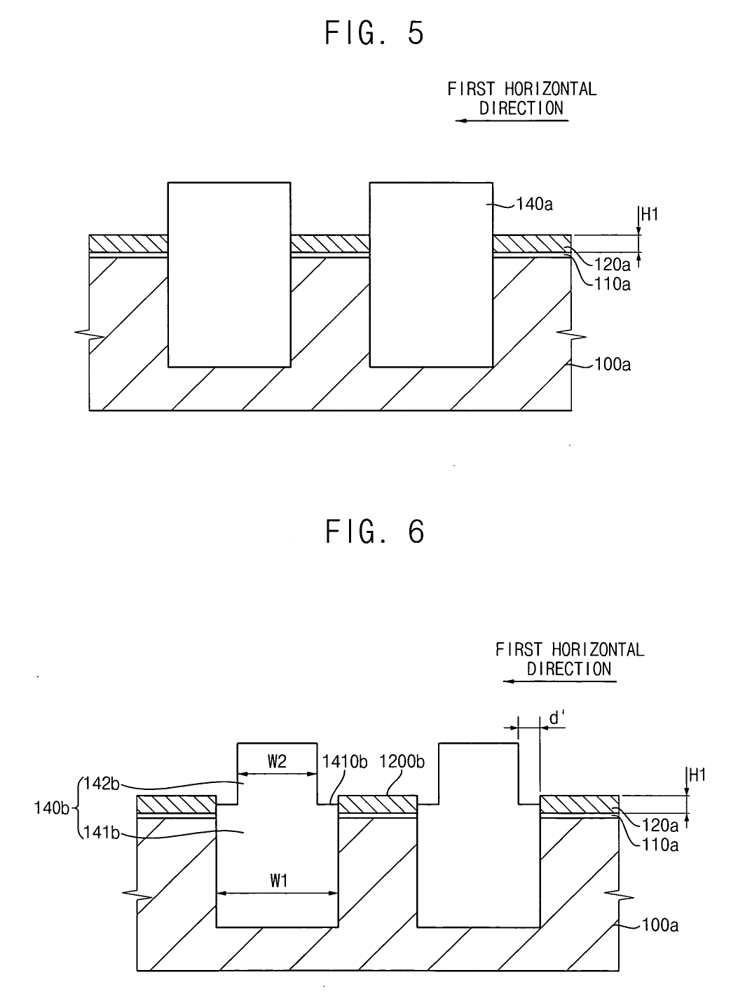

Referring to FIG. 5, the mask layer pattern 130 may be removed. If the mask layer pattern 130 is formed of silicon nitride, then the mask layer pattern 130 may be removed using phosphoric acid.

Referring to FIG. 6, after the mask layer pattern 130 is removed, an exposed portion (i.e. an upper portion) of the preliminary second insulating layer pattern 140a may be etched so that the preliminary second insulating layer pattern 140a may be transformed into a second insulating layer pattern 140b having a lower portion 141b and an upper portion 142b. If the preliminary second insulating layer pattern 140a is formed of silicon oxide, then the exposed portion of the preliminary second insulating layer pattern 140a may be etched using hydrogen fluoride.

The lower portion 141b of the second insulating layer pattern 140b may have a first width W₁ in the first horizontal direction. The upper portion 142b of the second insulating layer pattern 140b may have a second width W₂ in the first horizontal direction. The second width W₂ may be smaller than the first width W₁. The upper portion 142b of the second insulating layer pattern 140b may be spaced apart from the preliminary first conductive layer pattern 120a by a distance d′. This is because the second insulating layer pattern 140b is formed by etching the exposed portion of the preliminary insulating layer pattern 140a. An upper surface 1410b of the lower portion 141b may be positioned lower than an upper surface 1200b of the preliminary first conductive layer pattern 120a.

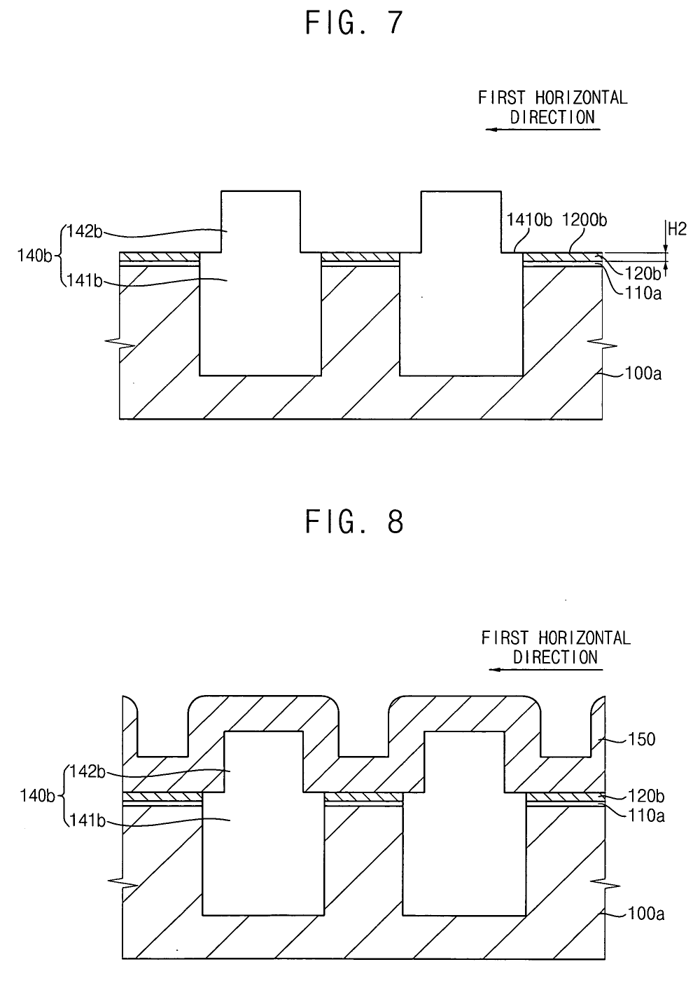

Referring to FIG. 7, an upper portion of the preliminary first conductive layer pattern 120a having the first height H₁ may be removed. A first conductive layer pattern 120b having a second height, H₂, smaller than the first height H₁ may be formed. A ratio of the second height H₂ to the first height H₁ may be about 3:5. For example, if the first height H₁ is about 250 nm, then the second height H₂ is about 150 nm. When the upper portion of the preliminary first conductive layer pattern 120a is removed, the upper surface 1200b of the first conductive layer pattern 120b may be substantially coplanar with the upper surface 1410b of the lower portion 141b.

If the preliminary first conductive layer pattern 120a is formed of polysilicon doped with impurities, then the surface of the preliminary first conductive layer pattern 120a may be removed using an etching solution including ammonium hydroxide and deionized water.

In other example embodiments, the etching solution may include ammonium hydroxide, hydrogen peroxide and/or deionized water. In yet other example embodiments, the etching solution may include nitric acid, acetic acid, hydrogen fluoride and/or deionized water.

Referring to FIG. 8, a second conductive layer 150 may be formed on the second insulating layer pattern 140b and the first conductive layer pattern 120b. The second conductive layer 150 may conform to (or have a similar shape as) the second insulating layer pattern 140b and the first conductive layer pattern 120b.

The second conductive layer 150 may be formed of a conductive material (e.g., metal or polysilicon doped with impurities). The second conductive layer 150 may be formed of the same conductive material as the first conductive layer pattern 120b.

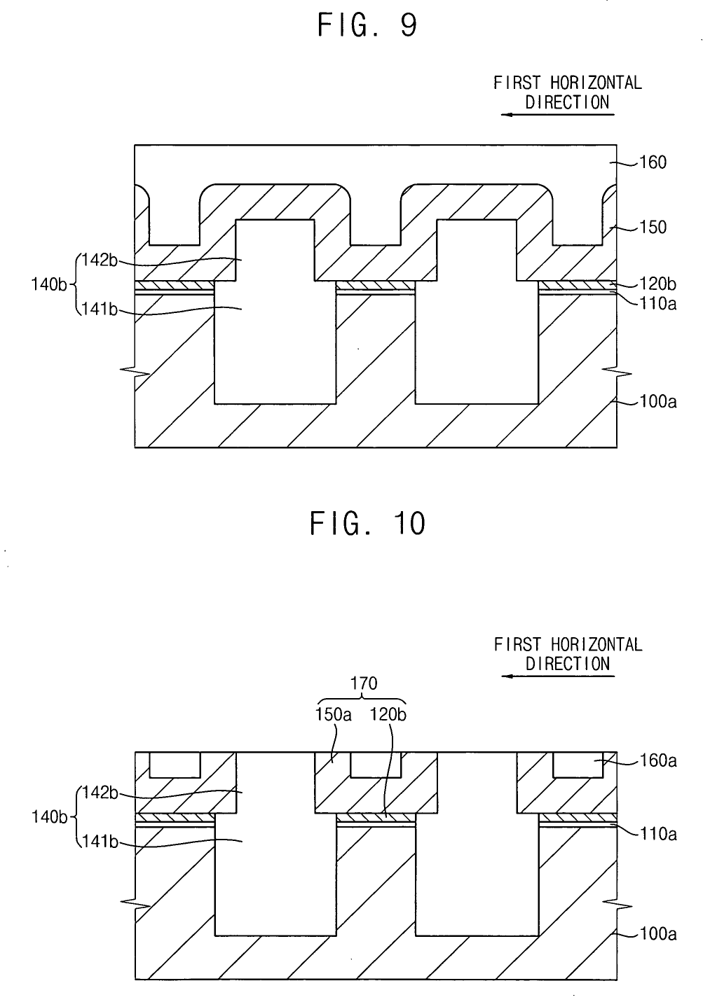

Referring to FIG. 9, a third insulating layer 160 may be formed on the second conductive layer 150. The third insulating layer 160 may be formed of an insulating material (e.g., silicon oxide). The third insulating layer 160 may be formed of the same insulating material as the second insulating layer pattern 140b.

Referring to FIG. 10, a planarizing process may be performed on the third insulating layer 160 and the second conductive layer 150 such that the second insulating layer pattern 140b is exposed. The third insulating layer 160 and the second conductive layer 150 may be etched, or polished, forming a third insulating layer pattern 160a and a second conductive layer pattern 150a, respectively. A conductive structure 170 including the first conductive layer pattern 120b and the second conductive layer pattern 150a may be formed. The planarizing process may be a CMP process or an etch-back process, used alone or in a combination thereof.

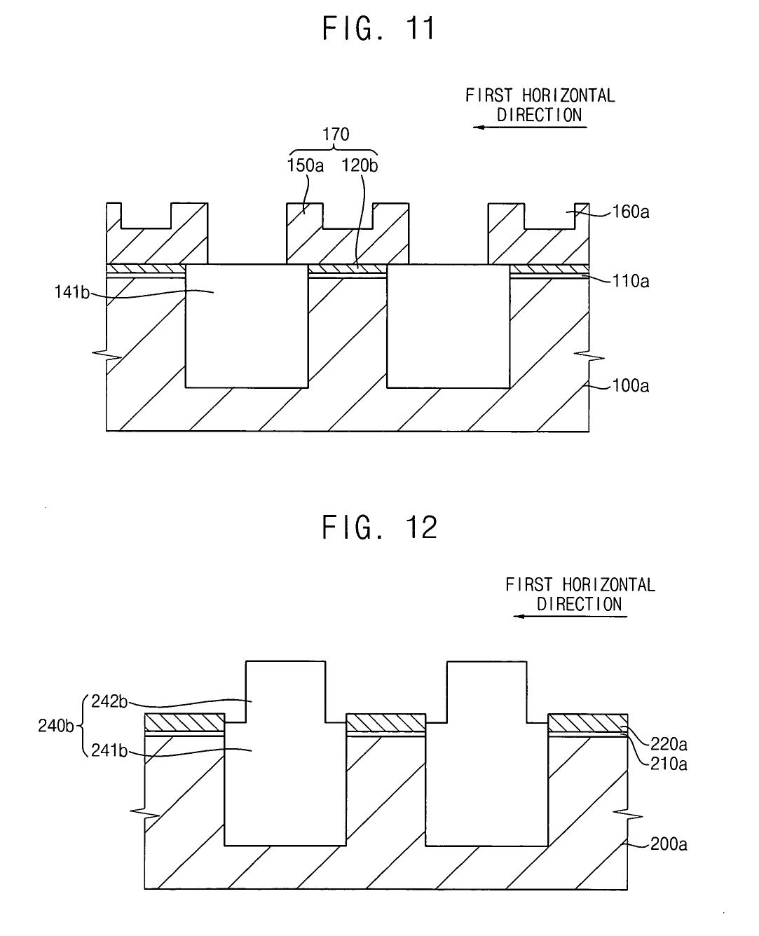

Referring to FIG. 11, the third insulating layer pattern 160a and the upper portion 142b of the second insulating layer pattern 140b may be removed. The conductive structure 170 including the first conductive layer pattern 120b and the second conductive layer pattern 150a may be exposed.

If the third insulating layer pattern 160a and the upper portion 142b of the second insulating layer pattern 140b are formed of silicon oxide, then the second insulating layer pattern 140b and the third insulating layer pattern 160a may be removed using hydrogen fluoride.

Although not shown in FIG. 11, the conductive structure 170 may be bisected in the first horizontal direction such that conductive members spaced apart from each other along the first and second horizontal directions are formed. The conductive members may be used as floating gates of a non-volatile memory device.

FIGS. 12 to 17 are diagrams illustrating cross-sectional views of another method of forming a conductive structure according to example embodiments. FIGS. 12 to 17 are cross-sectional views taken along a first horizontal direction.

Referring to FIG. 12, a substrate 200a, a first insulating layer pattern 210a, a first conductive layer pattern 220a and a second insulating layer pattern 240b having a lower portion 241b and an upper portion 242b may be formed in a similar manner as illustrated in FIGS. 1 to 6. The first conductive layer pattern 220a in FIG. 12 may be the same as the preliminary first conductive layer pattern 120a in FIGS. 2 to 6. Therefore, further explanation will be omitted.

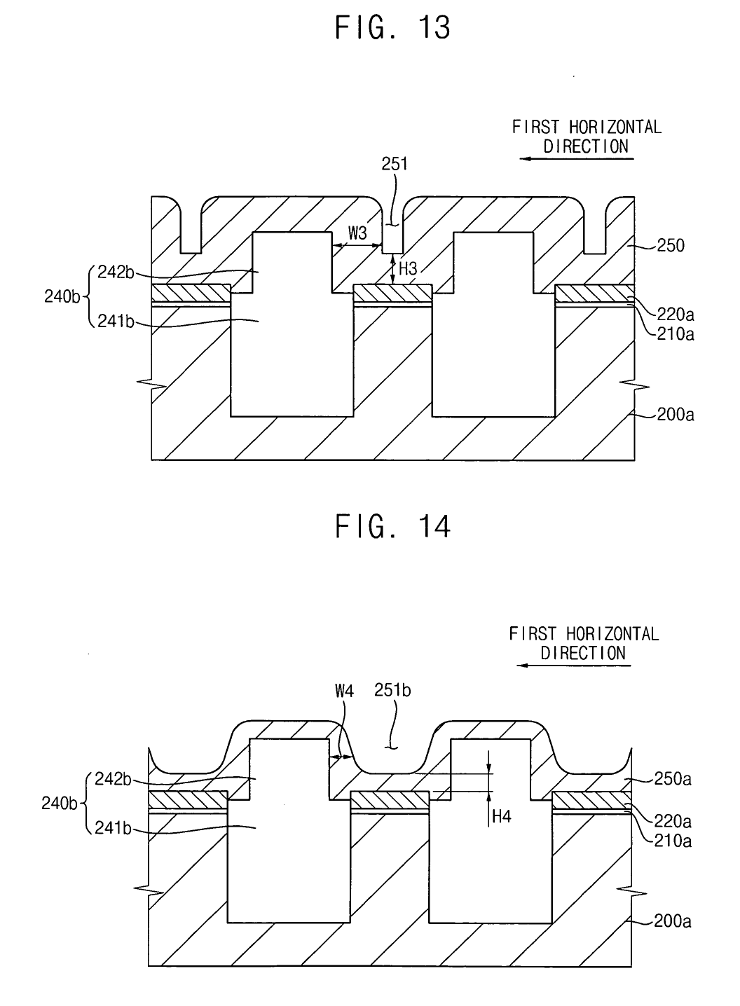

Referring to FIG. 13, a preliminary second conductive layer 250 may be formed on the second insulating layer pattern 240b and the first conductive layer pattern 220a.

The preliminary second conductive layer 250 may conform to (or have a similar shape as) the second insulating layer pattern 240b and the first conductive layer pattern 220a. The preliminary second conductive layer 250 may have a plurality of preliminary grooves 251 positioned over the first conductive layer pattern 220a.

The preliminary second conductive layer 250 may have a third width W₃ between a sidewall of the upper portion 242b of the second insulating layer pattern 240b and the preliminary groove 251 in the first horizontal direction. The preliminary second conductive layer 250 may have a third height H₃ between the first conductive layer pattern 220a and the preliminary groove 251.

Referring to FIG. 14, a surface of the preliminary second conductive layer 250 may be removed to form a second conductive layer 250a. The second conductive layer 250a may have grooves 251b positioned over the first conductive layer pattern 220a. The grooves 251 may be substantially larger than the preliminary grooves 251.

The second conductive layer 250a may have a fourth width W₄ between the sidewall of the upper portion 242b of the second insulating layer pattern 240b and the groove 251b in the first horizontal direction. The fourth width W₄ may be substantially smaller than the third width W₃. The second conductive layer 250a may have a fourth height H₄ between the first conductive layer pattern 220a and the groove 251b. The fourth height H₄ may be substantially smaller than the third height H₃. A ratio of the fourth height H₄ with respect to the third height H₃ may be about 4:7. For example, if the third height H₃ is about 350 nm, then the fourth height H₄ may be about 200 nm.

If the preliminary second conductive layer 250 includes polysilicon doped with impurities, then the surface of the preliminary second conductive layer 250 may be removed using an etching solution including ammonium hydroxide and deionized water. In example embodiments, the etching solution may include ammonium hydroxide, hydrogen peroxide and/or deionized water. In yet other example embodiments, the etching solution may include nitric acid, acetic acid, hydrogen fluoride and/or deionized water.

Referring to FIG. 15, a third insulating layer 260 may be formed on the second conductive layer 250a.

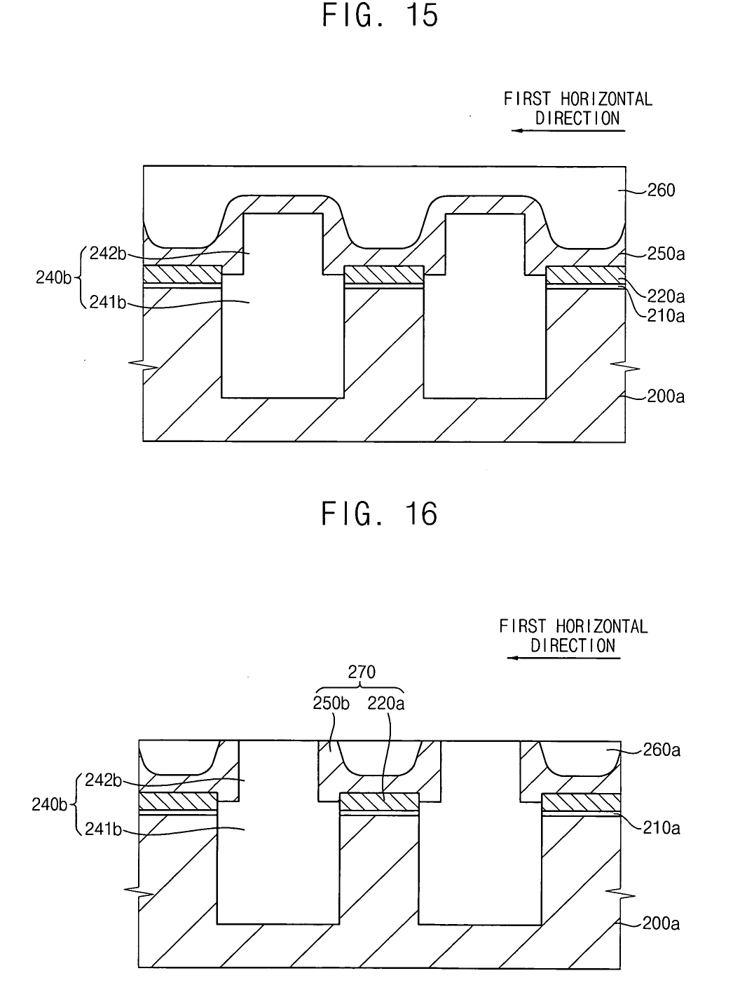

Referring to FIG. 16, a planarizing process may be performed on the third insulating layer 260 and the second conductive layer 250a such that the second insulating layer pattern 240 is exposed. The third insulating layer 260 and the second conductive layer 250a may be etched or polished forming a third insulating layer pattern 260a and a second conductive layer pattern 250b, respectively. A conductive structure 270 including the first conductive layer pattern 220a and the second conductive layer pattern 250b may be formed.

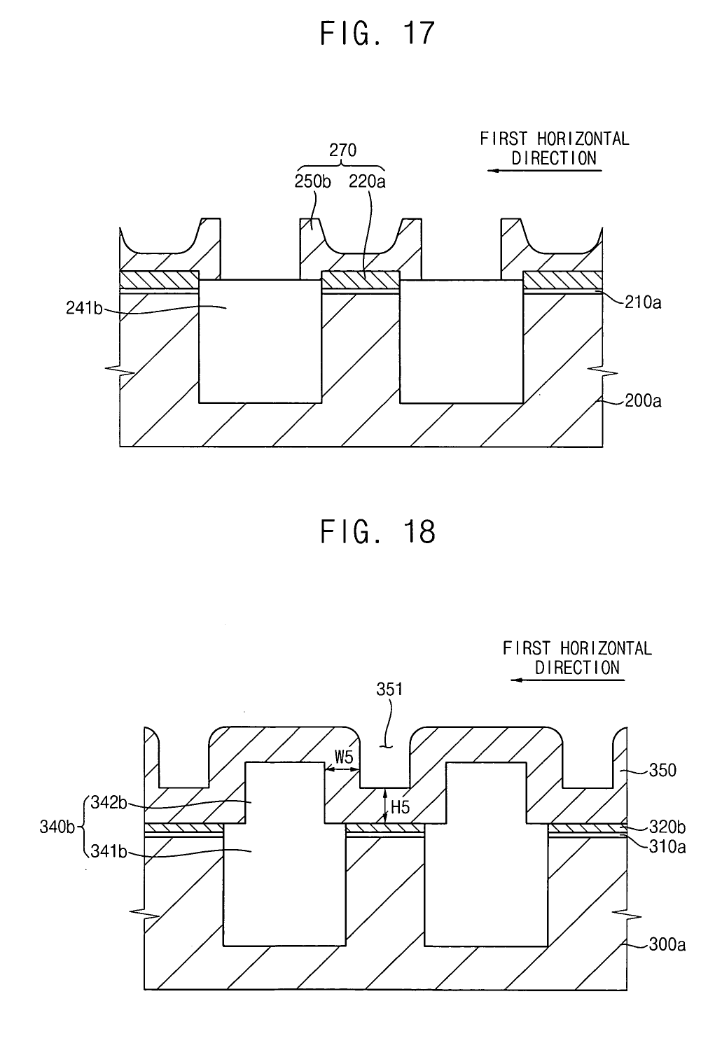

Referring to FIG. 17, the third insulating layer pattern 260a and the upper portion 242b of the second insulating layer pattern 240b may be removed. Although not shown in FIG. 17, the conductive structure 270 may be bisected in the first horizontal direction to form conductive members spaced apart from each other along the first and second horizontal directions.

FIGS. 18 to 22 are diagrams illustrating cross-sectional views of a method of forming a conductive structure according to example embodiments. FIGS. 18 to 22 are cross-sectional views in a first horizontal direction.

Referring to FIG. 18, a substrate 300a, a first insulating layer pattern 310a, a first conductive layer pattern 320b and a second insulating layer pattern 340b having a lower portion 341b and an upper portion 342b may be formed by a similar method as illustrated in FIGS. 1 to 8. Therefore, further explanation will be omitted.

A preliminary second conductive layer 350 may be formed on the second insulating layer pattern 340b and the first conductive layer pattern 320b. The preliminary second conductive layer 350 may conform to (or have a similar shape as) the second insulating layer pattern 340b and the first conductive layer pattern 320b. The preliminary second conductive layer 350 may have preliminary grooves 351 positioned over the first conductive layer pattern 320b.

The preliminary second conductive layer 350 may have a fifth width W₅ between a sidewall of the upper portion 342b of the second insulating layer pattern 340b and the preliminary groove 351 in the first horizontal direction. The preliminary second conductive layer 350 may have a fifth height H₅ between the first conductive layer pattern 320b and the preliminary groove 351.

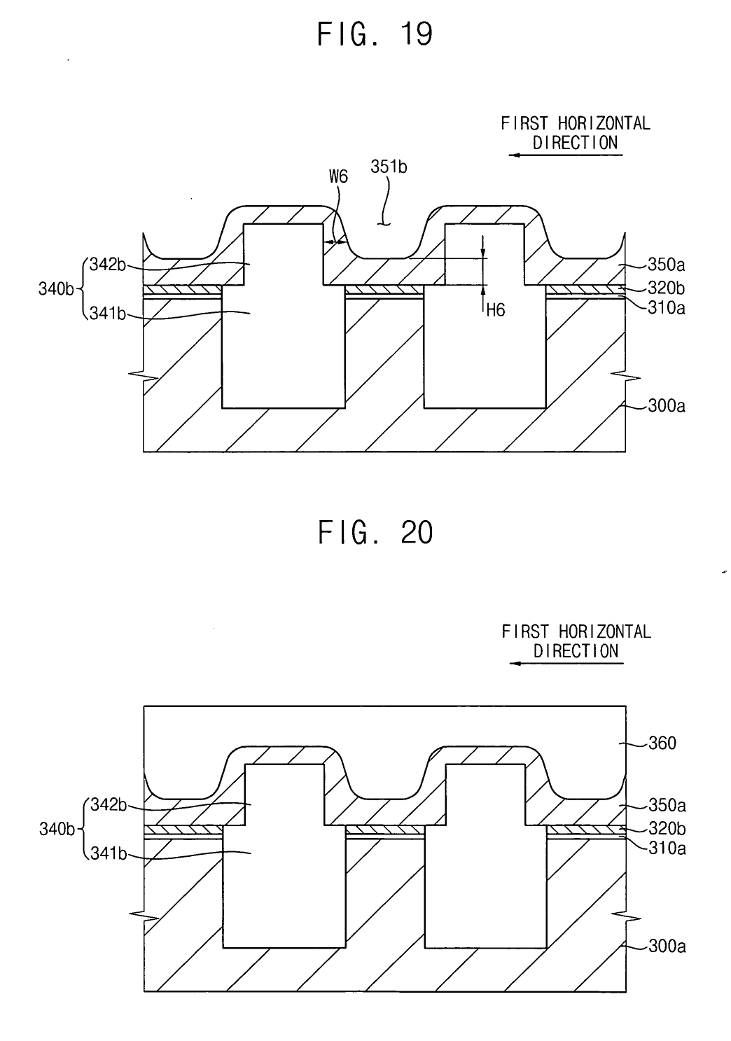

Referring to FIG. 19, a portion (or surface) of the preliminary second conductive layer 350 may be removed to form a second conductive layer 350a. The second conductive layer 350a may have a plurality of grooves 351b positioned over the first conductive layer pattern 320b. The grooves 351b may be substantially larger than the preliminary grooves 351.

The second conductive layer 350a may have a sixth width, W₆, between the sidewall of the upper portion 342b of the second insulating layer pattern 340b and the groove 351b in the first horizontal direction. The sixth width W₆ may be substantially smaller than the fifth width W₅. The second conductive layer 350a may have a sixth height H₆ between the first conductive layer pattern 320b and the groove 351b. The sixth height H₆ may be smaller than the fifth height H₅. A ratio of the sixth height H₆ to the fifth height H₅ may be about 4:7. For example, if the fifth height H₅ is about 350 nm, then the sixth height may be about 200 nm.

If the preliminary second conductive layer 350 includes polysilicon doped with impurities, then the surface of the preliminary second conductive layer 350 may be removed using an etching solution including ammonium hydroxide and deionized water. In other example embodiments, the etching solution may include ammonium hydroxide, hydrogen peroxide and deionized water. In yet other example embodiments, the etching solution may include nitric acid, acetic acid, hydrogen fluoride and/or deionized water.

Referring to FIG. 20, a third insulating layer 360 may be formed on the second conductive layer 350a.

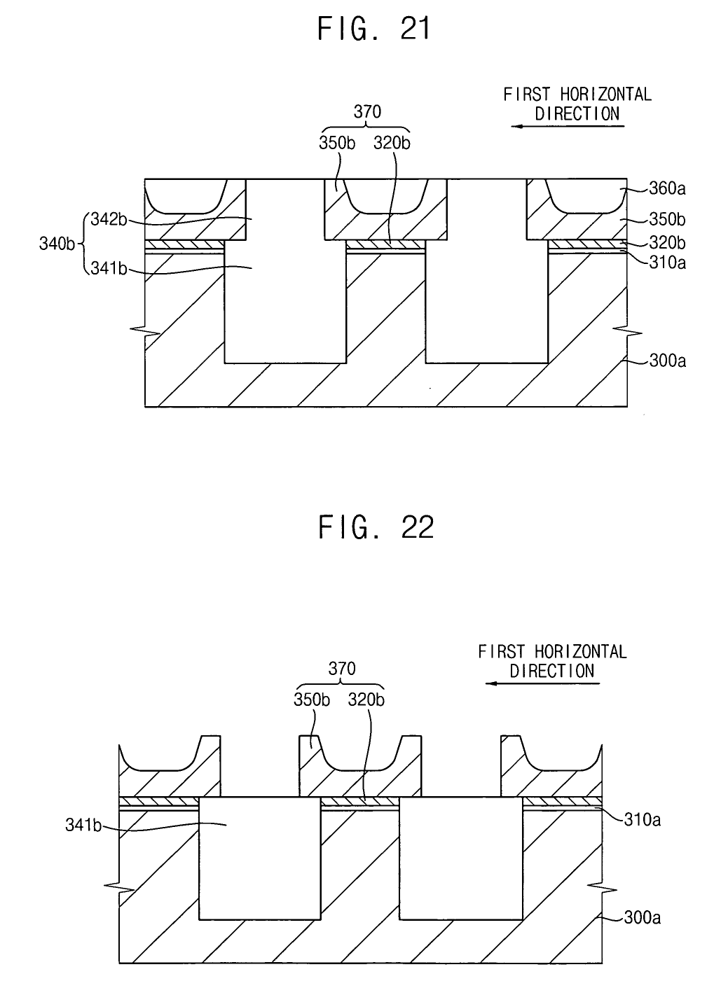

Referring to FIG. 21, a planarizing process may be performed on the third insulating layer 360 and the second conductive layer 350a such that the second insulating layer pattern 340b is exposed. The third insulating layer 360 and the second conductive layer 350a may be etched, or polished, forming the third insulating interlayer pattern 360a and second conductive layer pattern 350b, respectively. A conductive structure 370 including the first conductive layer pattern 320b and the second conductive layer pattern 350b may be formed.

Referring to FIG. 22, the third insulating layer pattern 360a and the upper portion 342b of the second insulating layer pattern 340b may be removed. Although not shown in FIG. 22, the conductive structure 370 may be bisected in the first horizontal direction such that conductive members spaced apart from each other along the first and second horizontal directions may be formed.

According to example embodiments, a sectional area, may be reduced, wherein the sectional area is formed as a result of vertically bisecting a conductive structure (extending in a first horizontal direction) in a second direction substantially perpendicular to the first horizontal direction.

If the conductive structure is vertically cut in the second horizontal direction to form conductive members each having at least one first sidewall facing a first sidewall of another conductive member in the first horizontal direction and possibly at least one second sidewall facing a second sidewall of another conductive member in the second horizontal direction, then a coupling effect generated between first sidewalls that are adjacent to each other may be reduced.

According to example embodiments, the conductive structures 170, 270, 370 may be bisected, trisected or divided into more than three elements. In other example embodiments, the conductive structures 170, 270, 370 may be divided into two or more unequal elements.

The foregoing is illustrative of example embodiments and is not to be construed as limiting thereof. Although example embodiments have been described, those skilled in the art will readily appreciate that many modifications are possible in the embodiments without materially departing from the novel teachings and advantages of example embodiments. Accordingly, all such modifications are intended to be included within the scope of the claims. Therefore, it is to be understood that the foregoing is illustrative of example embodiments and is not to be construed as limited to the specific embodiments disclosed, and that modifications to the disclosed embodiments, as well as other embodiments, are intended to be included within the scope of the appended claims. Example embodiments are defined by the following claims, with equivalents of the claims to be included therein.

What is claimed is:

1. A method of forming a conductive structure, comprising:
forming insulating layer patterns including a lower section having first width, w₁, and an upper section having second width, w₂, wherein the expression w₂<w₁ is satisfied; and
forming conductive layer patterns by removing at least a portion of an upper surface of at least one preliminary conductive structure, wherein the upper surface of the preliminary conductive structures is positioned higher than an upper surface of a section of the insulating layer pattern.

2. The method of claim 1, wherein forming the conductive layer patterns includes:
forming a preliminary first conductive layer pattern between the insulating layer patterns wherein the preliminary first conductive layer pattern is one of the preliminary conductive structures, further wherein the preliminary first conductive layer pattern has an upper surface positioned higher than an upper surface of the lower section;
forming a first conductive layer pattern by removing the upper surface of the preliminary first conductive layer pattern; and
forming a second conductive layer pattern on the first conductive layer pattern.

3. The method of claim 2, wherein the preliminary first conductive layer pattern includes polysilicon doped with impurities; and the upper surface of the preliminary first conductive layer pattern is removed using an etching solution including ammonium hydroxide and deionized water.

4. The method of claim 2, wherein the preliminary first conductive layer pattern includes polysilicon doped with impurities; and the upper surface of the preliminary first conductive layer pattern is removed using an etching solution including ammonium hydroxide, hydrogen peroxide and deionized water.

5. The method of claim 2, wherein the preliminary first conductive layer pattern includes polysilicon doped with impurities; and the upper surface of the preliminary first conductive layer pattern is removed using an etching solution including nitric acid, acetic acid, hydrogen fluoride and deionized water.

6. The method of claim 2, wherein the forming the second conductive layer pattern includes:
forming a preliminary second conductive layer on the insulating layer patterns and the first conductive layer pattern wherein the preliminary second conductive layer has an upper surface positioned higher than an upper surface of the upper section;
forming a second conductive layer by partially removing the upper surface of the preliminary second conductive layer, wherein the second conductive layer is another of the preliminary conductive structures, further wherein the second conductive layer has an upper surface positioned higher than the upper surface of the upper section; and
forming a second conductive layer pattern by removing the upper surface of the second conductive layer.

7. The method of claim 6, wherein the preliminary second conductive layer includes polysilicon doped with impurities; and the upper surface of the preliminary second conductive layer is removed using an etching solution including ammonium hydroxide and deionized water.

8. The method of claim 6, wherein the preliminary second conductive layer includes polysilicon doped with impurities; and the upper surface of the preliminary second conductive layer is removed using an etching solution including ammonium hydroxide, hydrogen peroxide and deionized water.

9. The method of claim 6, wherein the preliminary second conductive layer includes polysilicon doped with impurities; and the upper surface of the preliminary second conductive layer is removed using an etching solution including nitric acid, acetic acid, hydrogen fluoride and deionized water.

10. The method of claim 1, wherein forming the conductive layer patterns includes:
forming a first conductive layer pattern between the insulating layer patterns;
forming a preliminary second conductive layer on the insulating layer patterns and the first conductive layer pattern wherein the preliminary second conductive layer has an upper surface positioned higher than an upper surface of the upper section
forming a second conductive layer by partially removing the upper surface of the preliminary second conductive layer, wherein the second conductive layer is one of the preliminary conductive structures, further wherein the second conductive layer has an upper surface positioned higher than the upper surface of the upper section; and
forming a second conductive layer pattern by removing the upper surface of the second conductive layer.

11. The method of claim 10, wherein the forming the first conductive layer patterns includes:
forming a preliminary first conductive layer pattern between the insulating layer patterns wherein the preliminary first conductive layer pattern is another of the preliminary conductive structures, further wherein the preliminary first conductive layer pattern has an upper surface positioned higher than an upper surface of the lower section; and
removing the upper surface of the preliminary first conductive layer pattern.

12. The method of claim 10, wherein the preliminary second conductive layer includes polysilicon doped with impurities; and the upper surface of the preliminary second conductive layer is removed using an etching solution including ammonium hydroxide and deionized water.

13. The method of claim 10, wherein the preliminary second conductive layer includes polysilicon doped with impurities; and the upper surface of the preliminary second conductive layer is removed using an etching solution including ammonium hydroxide, hydrogen peroxide and deionized water.

14. The method of claim 10, wherein the preliminary second conductive layer includes polysilicon doped with impurities; and the upper surface of the preliminary second conductive layer is removed using an etching solution including nitric acid, acetic acid, hydrogen fluoride and deionized water.

15. The method of claim 11, wherein the preliminary first conductive layer pattern includes polysilicon doped with impurities; and the upper surface of the preliminary first conductive layer pattern is removed using an etching solution including ammonium hydroxide and deionized water.

16. The method of claim 11, wherein the preliminary first conductive layer pattern includes polysilicon doped with impurities; and the upper surface of the preliminary first conductive layer pattern is removed using an etching solution including ammonium hydroxide, hydrogen peroxide and deionized water.

17. The method of claim 11, wherein the preliminary first conductive layer pattern includes polysilicon doped with impurities; and the upper surface of the preliminary first conductive layer pattern is removed using an etching solution including nitric acid, acetic acid, hydrogen fluoride and deionized water.
